(19) United States
(12) Patent Application Publication
(10) Pub. No.: US 2025/0356598 A1
(43) Pub. Date: Nov. 20, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HIROKI WATABE, Tokyo (JP)

(21) Appl. No.: 19/194,345

(22) Filed: Apr. 30, 2025

(30) Foreign Application Priority Data
May 15, 2024 (JP) 2024-079579

(51) Int. Cl. G06T 19/00; G06T 19/20

(52) U.S. Cl. CPC G06T 19/006; G06T 19/20; G06T 2219/024; G06T 2219/2016

(57) ABSTRACT

An image processing apparatus of the present disclosure is an image processing apparatus for performing remote communication between a first user and a second user present in an environment different from an environment of the first user, including: an obtaining unit configured to obtain first environment information being information for determining three-dimensional shapes of surroundings around the first user, and second environment information being information for determining three-dimensional shapes of surroundings around the second user; and a determination unit configured to determine a play area for at least one of the first user and the second user for the remote communication based on the first environment information and the second environment information obtained by the obtaining unit.

### BACKGROUND OF THE INVENTION

### Field of the Invention

The present disclosure relates to a technology for controlling a range within which a user can move in a mixed reality (MR) space.

### Description of the Related Art

In recent years, there have been advancements in the development of next-generation communication systems that utilize MR to display, in front of the user, for example, a 3D model of another person, providing the user with an experience as if the other person were physically present. For example, such a next-generation communication system captures an image of a person at a remote location in real time with a camera and a 3D sensor, and creates that person's 3D model based on the captured image data. The communication system displays that in an MR space for a user wearing a head-mounted display (hereinafter referred to as “HMD”). In this way, the user can communicate with the person at the remote location as if the user were in the same space as that person.

Using an HMD sometimes involves setting up a range within which the user can move as a play area in advance based on the walls and obstacles around the user. Patent Document 1 (Japanese Patent Laid-Open No. 2018-190432) discloses a technology in which using an HMD is preceded by detecting a target object around the user in the real space and setting up a play area for the user with the target object as a reference point.

### SUMMARY OF THE INVENTION

An image processing apparatus of the present disclosure is an image processing apparatus for performing remote communication between a first user and a second user present in an environment different from an environment of the first user, including: an obtaining unit configured to obtain first environment information being information for determining three-dimensional shapes of surroundings around the first user, and second environment information being information for determining three-dimensional shapes of surroundings around the second user; and a determination unit configured to determine a play area for at least one of the first user and the second user for the remote communication based on the first environment information and the second environment information obtained by the obtaining unit.

Further features of the present invention will become apparent from the following description of exemplary embodiments with reference to the attached drawings.

### BRIEF DESCRIPTION OF THE DRAWINGS

FIG. 1 is a configuration diagram of an HMD system as an image processing system;

FIG. 2 is a diagram illustrating an internal configuration of an HMD;

FIG. 3 is a diagram illustrating a hardware configuration of an image processing apparatus;

FIG. 4 is a diagram illustrating a functional configuration of an image processing apparatus in a first embodiment;

FIG. 5 is a flowchart illustrating an entire flow of a process in the first embodiment;

FIGS. 6A to 6C are diagrams illustrating the concept of a first play area determination process in the first embodiment;

FIG. 7 is a flowchart illustrating a flow of the first play area determination process in the first embodiment;

FIG. 8 is a diagram illustrating a display example of a play area in the first embodiment;

FIGS. 9A to 9D are diagrams illustrating another example of the play area determined in the first embodiment;

FIGS. 10A to 10C are diagrams illustrating an example of a play area determined in Modification 1;

FIGS. 11A to 11C are diagrams illustrating an example of a play area determined in Modification 2;

FIG. 12 is a diagram illustrating a functional configuration of an image processing apparatus in a second embodiment;

FIGS. 13A to 13C are diagrams illustrating the concept of a first play area determination process in the second embodiment;

FIG. 14 is a flowchart illustrating a flow of the first play area determination process in the second embodiment;

FIGS. 15A and 15B are diagrams illustrating another example of the play area determined in the second embodiment;

FIGS. 16A to 16C are diagrams illustrating another example of the play area determined in the second embodiment;

FIG. 17 is a diagram illustrating a functional configuration of an image processing apparatus in a third embodiment;

FIGS. 18A and 18B are diagrams illustrating the concept of a first play area determination process in the third embodiment;

FIG. 19 is a flowchart illustrating a flow of the first play area determination process in the third embodiment; and

FIGS. 20A and 20B are diagrams illustrating an example of a play area determined in a modification of the third embodiment.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically.

In remote communication using MR, a problem may occur in which a 3D model of one user appears to be partly sticking into a wall in the room of the other user. For example, consider a case where a first user is in a room larger than the room of the second user during remote communication between the first and second users. According to the technology disclosed in Patent Literature 1, a play area for the first user is set up based on the positions of the walls in the room of the first user. The first user can therefore move to the walls in the room of the first user. Here, since the room of the second user is smaller than the room of the first user, positions near the walls in the room of the first user are situated outside the room of the second user. For this reason, the 3D model of the first user appears to be partly sticking into a wall from the perspective of the second user.

### First Embodiment

Each of the following embodiments will be described based on a situation where two users in different rooms are wearing HMDs on their heads and performing remote communication with each other through a network. In each room, multiple cameras and 3D sensors not illustrated are installed and, based on image data captured by these, a 3D model of the user is created and displayed in real time on the HMD of the other user at the remote location. As a result, an MR space is generated in one user's real space in which the other user appears as if present in the real space.

An image processing system (HMD system 1) determines individual play areas for a first user (e.g., host user) and a second user (e.g., a communication partner) based on environment information of the real space in which the first user is present and environment information of the real space in which the second user is present. A first embodiment will exemplarily describe an example in which an image processing apparatus connected to the HMD used by the first user determines the play area for the first user based on the three-dimensional shape of the room which the first user is in and the three-dimensional shape of the room which the second user is in. A play area refers to a range in a real space within which a real user can move. Note that an image processing apparatus connected to the HMD used by the second user executes the same process to determine the play area for the second user.

### (Configuration of Image Processing Apparatus)

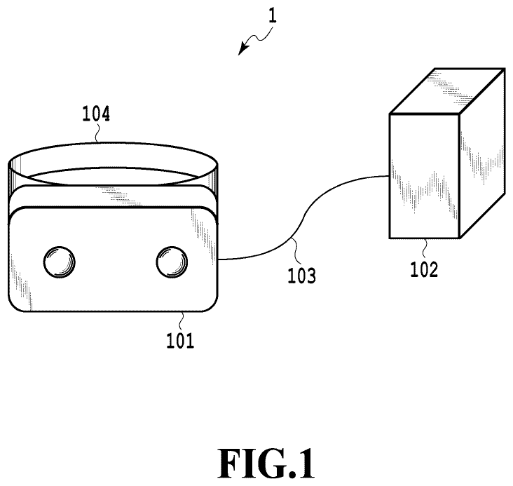

FIG. 1 illustrates a configuration of the HMD system 1 as an image processing system in the present disclosure. The HMD system 1 includes an HMD 101 and an image processing apparatus 102, which are connected to each other through a transmission path 103 and communicate image data, control signals, and so on. The transmission path 103 includes video signal lines, such as a High-Definition Multimedia Interface (HDMI (registered trademark)) cable, and data signal lines, such as a Universal Serial Bus (USB) cable. Also, in order to receive inputs from the user, input devices not illustrated, such as a controller and a keyboard, are communicatively connected to the image processing apparatus 102. The form of communication connection between the HMD 101 and the image processing apparatus 102 and the form of communication connection between the image processing apparatus 102 and the input devices may be wired connections, such as USB cables, or wireless connections, such as Bluetooth (registered trademark).

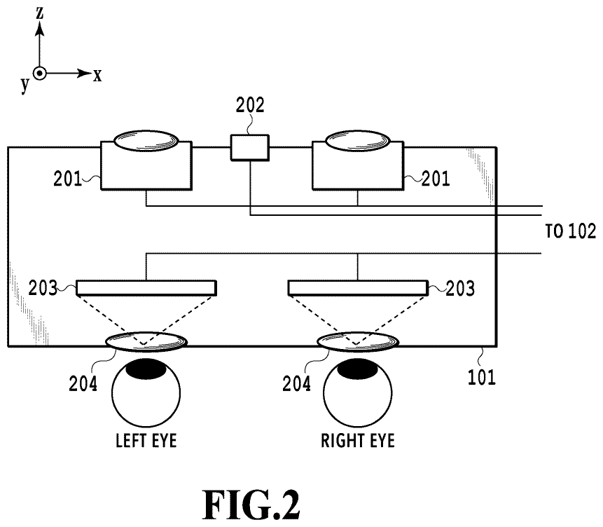

FIG. 2 illustrates an internal configuration of the HMD 101. The HMD 101 has an inertial measurement unit (IMU) including multiple RGB cameras 201 and 201, a gyro sensor and acceleration sensor not illustrated, and so on in order to implement position tracking. Further, the HMD 101 includes a range sensor 202, such as a light detection and ranging (LiDAR) unit, in order to obtain depth information. Also, the HMD 101 has displays 203 and 203 for the left and right eyes in order to display images. The displays 203 and 203 include display panels, such as liquid crystal panels or organic light emitting diode (OLED) panels, for example. Further, eyepiece lenses 204 and 204 for the left and right eyes are disposed in front of the displays 203 and 203, respectively. Through these eyepiece lenses 204 and 204, the user of the HMD 101 can observe enlarged virtual images of display images displayed on the displays 203 and 203. The HMD 101 is worn on the head of the user with a band 104 and let the user's left eye and right eye observe (enlarged virtual images of) a left-eye display image and a right-eye display image, respectively.

The image processing apparatus 102 performs a process of generating the left-eye display image and the right-eye display image and displays these images on the displays 203 and 203 of the HMD 101, respectively. At this time, it is possible to provide the user with a visual experience with a sense of depth by applying appropriate parallax between the left-eye display image and the right-eye display image.

The coordinates axes illustrated in FIG. 2 represent coordinate axes pertaining to the position and orientation of the HMD 101. In the present embodiment, information on the position and orientation of the HMD 101 is obtained on the assumption that the direction of gravity is the y direction, the viewing direction of the user is the z direction, and the direction perpendicular to the y direction and the z direction is the x direction.

The present embodiment, which will be described assuming a system configuration in which the image processing apparatus 102 is independent of the HMD 101, may employ the configuration of an integrated HMD system including the HMD 101 with the image processing apparatus 102 incorporated therein or the like.

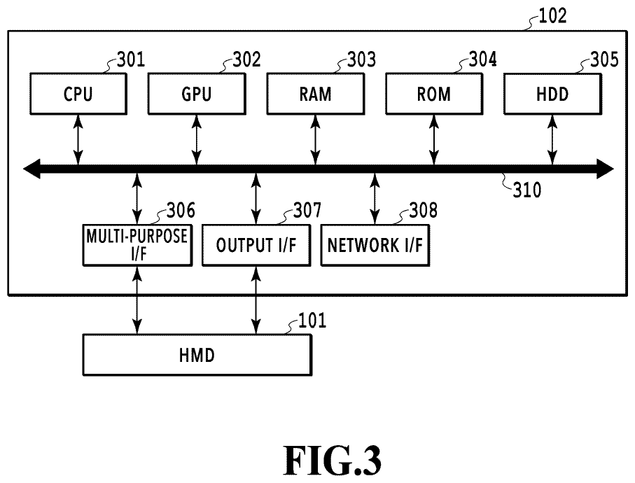

FIG. 3 is a diagram illustrating an example of a configuration of the image processing apparatus 102 according to the present disclosure. A central processing unit (CPU) 301 is a processor that comprehensively controls elements in the image processing apparatus 102. A graphics processing unit (GPU) 302 is a processor that performs image processing in response to receiving a command from the CPU 301. The GPU 302 creates a display image to be displayed on the HMD 101 by, for example, performing rendering on virtual objects and superimposing the virtual objects over real images obtained by the RGB cameras 201 of the HMD 101. A random-access memory (RAM) 303 functions as a main memory, a work area, and the like for the CPU 301. A read-only memory (ROM) 304 stores a set of programs to be executed by the CPU 301. A hard disk drive (HDD) 305 stores applications to be executed by the CPU 301, data to be used in the image processing, and so on.

A multi-purpose I/F 306 is a serial bus interface complying with USB, IEEE 1394, or the like and is connected to the IMU and the range sensor included in the HMD 101. In this way, position-orientation information, depth images to target objects, and so on can be obtained from the HMD 101. Also, the multi-purpose I/F 306 is used to obtain real images from the RGB cameras 201 of the HMD 101. An output I/F 307 is an interface such as HDMI, DisplayPort, or the like and is used to display images on the displays 203 of the HMD 101. A network I/F 308 communicates with the HMD 101 used by the other person through a network, such as a local area network (LAN) or the Internet, based on control by the CPU 301. A system bus 310 is responsible for the flow of data in the apparatus. Note that the image processing apparatus 102 may include constituent elements other than the above.

### (Functional Configuration of Image Processing Apparatus)

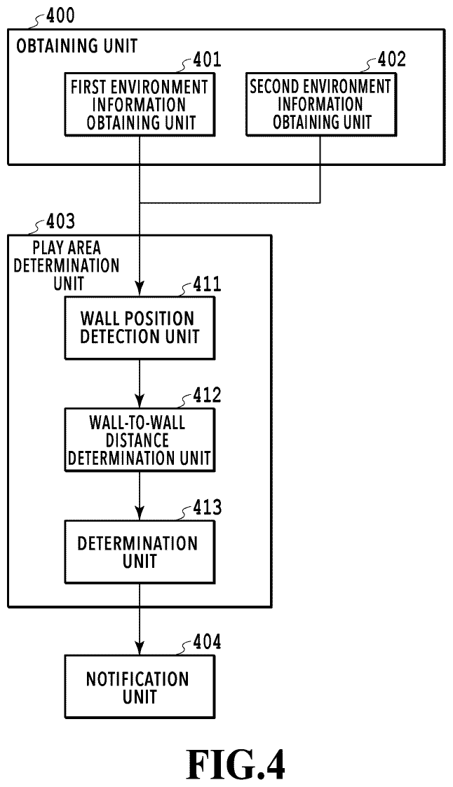

FIG. 4 is a diagram illustrating a functional configuration of the image processing apparatus 102 in the first embodiment. The image processing apparatus 102 has an obtaining unit 400, a play area determination unit 403, and a notification unit 404. The obtaining unit 400 includes a first environment information obtaining unit 401 and a second environment information obtaining unit 402. The play area determination unit 403 has a wall position detection unit 411, a wall-to-wall distance determination unit 412, and a determination unit 413. These functional units are implemented by the CPU 301 or the GPU 302 executing processes based on programs stored in the ROM 304 or the HDD 305.

The first environment information obtaining unit 401 obtains first environment information which is information on the environment around the first user. The first user is, for example, the host user.

The second environment information obtaining unit 402 obtains second environment information which is information on the environment around the second user. The second user is, for example, a person who is present in a different environment from the first user and with whom the first user performs the remote communication.

The environment information is information for detecting the three-dimensional shape of the real space in which the user is present. In the present embodiment, the environment information obtaining units 401 and 402 each obtain real images, a depth image, and position-orientation information as the environment information. The real images are images of the real space captured under visible light by the RGB cameras 201 and 201 of the HMD 101 used by the user. The real images are moving images captured at a predetermined frame rate. The depth image is an image containing information on the distances from the viewpoint position of the user to objects in the depth direction, and is obtained at a predetermined rate by the range sensor 202 of the HMD 101. The position-orientation information is information detected at a predetermined rate by the IMU of the HMD 101, and is information on the position and orientation of the user. The image capturing time of each of the frames of the real images and the depth image and the obtaining time of the position-orientation information are associated with each other.

The environment information obtaining units 401 and 402 determine the three-dimensional shapes of the surroundings around the users (environment maps) based on the obtained real images, depth images, and position-orientation information. These are obtained in the form of three-dimensional point cloud data, for example. A simultaneous localization and mapping (SLAM; simultaneous execution of self-localization and environment mapping) technology is available as a method of determining the three-dimensional shapes of the surroundings around each user. The present embodiment exemplarily uses a technique called Visual SLAM which obtains environment information based on images obtained from cameras or image sensors. Note that the method of obtaining the environment information is not limited to this, and a SLAM technology using Lidar or another technique may be used.

The HMD 101 sets a position on the floor surface present directly under the first position that the HMD 101 detects after being powered on, for example, as an origin (0, 0, 0) for the user position. Also, the HMD 101 sets the direction of gravity as a height direction axis (y), the viewing direction of the user in a plane perpendicular to the height direction as a depth direction axis (Z), and the direction perpendicular to the depth direction and the height direction as a lateral direction axis (x). Also, as for the tilt (orientation), the IMU detects the rotation angles in the roll, pitch, and yaw directions. In a case of starting a process of setting up the play area, the HMD 101 instructs the user to look around. As a result, the RGB cameras 201 and 201 capture images of objects around the user, such as the walls, the floor, and the ceiling, as real images. The IMU obtains the position-orientation information of the HMD 101 during the image capture as well. Also, the range sensor 202 obtains information on the distances between the objects and the HMD 101.

The HMD 101 transmits the obtained real images, position-orientation information, and distance information (depth information) to the image processing apparatus 102. Based on the real images, the position-orientation information, and the distance information (depth information), the image processing apparatus 102 determines three-dimensional shape data of the surroundings around the user by Visual SLAM mentioned above or the like. The three-dimensional shape data is obtained in the form of point cloud data indicating the three-dimensional positions of feature points on objects, including the walls, the floor, and the ceiling, for example.

The wall position detection unit 411 detects the positions of the walls around the first user based on the first environment information obtained by the first environment information obtaining unit 401, i.e., the three-dimensional shape data of the surroundings around the first user. Also, the wall position detection unit 411 detects the positions of the walls around the second user based on the second environment information obtained by the second environment information obtaining unit 402, i.e., the three-dimensional shape data of the surroundings around the second user. In this specification, a “wall” means a surface standing substantially perpendicularly on a floor surface.

The wall position detection unit 411 detects wall regions around the first user from the real images obtained by the first environment information obtaining unit 401 by using an object detection algorithm, such as You Only Look Once (YOLO), for example. Then, the wall position detection unit 411 associates the detected wall regions with the three-dimensional shape data derived by Visual SLAM. As a result, each of the three-dimensional positions of the multiple wall regions present around the first user is determined. Visual SLAM and YOLO are publicly known technologies, and description thereof is therefore omitted. Note that the method of detecting the wall regions is not limited to this, and any technique may be used. For example, Convolutional Neural Network (CNN) SLAM may be used to determine the three-dimensional shape data of the room and to detect the wall regions. The detection of the wall regions allows the room region in the three-dimensional shape data to be identified. That is, the room region is a region surrounded by the wall regions.

Each set of coordinates representing the space of the room region (hereinafter, also referred to simply as “room”) is held as data in a separate coordinate system that is not dependent on the viewpoint position or the viewing direction of the user (HMD 101). For example, in the room's coordinate system, the position of the center of the room is set as the origin, the direction of gravity is set as a height direction (H) axis, the direction of a straight line connecting the centers of a pair of facing wall regions is set as a depth direction (D) axis, and the direction horizontally rotated 90° from the depth direction is set as a lateral direction (W) axis. Note that the method of defining of the origin and the coordinate axes is not limited to this. For example, a marker placed in advance in the real space of the room or a predetermined feature point (e.g., one of the four corners of the room) may be set as the origin. The coordinate axes may be determined depending on the application.

For the second user's room too, the wall position detection unit 411 similarly detects the wall regions around the second user based on the second environment information. As a result, the room region of the second user is identified.

Based on the positions of the walls in the room of the first user detected by the wall position detection unit 411, the wall-to-wall distance determination unit 412 determines the distances between facing walls in at least two directions that are perpendicular to the height direction. In a case where the shape of the room in a horizontal plane is rectangular, a pair of facing walls is detected for each of two directions that are perpendicular to each other. These two directions are the depth direction (first direction) and the lateral direction (second direction) in the room of the first user. The wall-to-wall distance determination unit 412 determines the distance between two facing walls for each of the two directions. The wall-to-wall distances in these two directions determine the size of the room.

For the room of the second user too, based on the positions of the walls in the room of the second user detected by the wall position detection unit 411, the wall-to-wall distance determination unit 412 determines the distances between facing walls in at least two directions that are perpendicular to the height direction.

The determination unit 413 compares the distance between the facing walls in the room of the first user in each of the above two perpendicular directions determined by the wall-to-wall distance determination unit 412 and that of the room of the second user to each other. Then, based on the smaller distance in each of the directions in the comparison, the determination unit 413 determines the play area ranges for the first and second users. The determination unit 413 places a play area with the determined ranges in the room of the first user. As a result, a first play area is determined.

The first play area has a range in each of the height direction, the first direction perpendicular to the height direction (e.g., depth direction), and the second direction perpendicular to the height direction and the first direction (e.g., lateral direction). Details of a process of determining the play area will be described later.

The notification unit 404 notifies the first user of the first play area determined by the determination unit 413. Examples of the notification method include displaying the first play area on the displays. Specifically, the notification unit 404 displays translucent virtual objects at the boundary surfaces between the inside and outside of the first play area. Note that the notification method is not limited to a method involving visual representation, and may be another method. For example, the notification unit 404 may output a sound from a speaker of the HMD 101 not illustrated or generate a vibration with a vibrator of the HMD 101 not illustrated to warn (notify) the user in a case where the user gets close to the boundary of the play area.

### (Process Executed by Image Processing Apparatus)

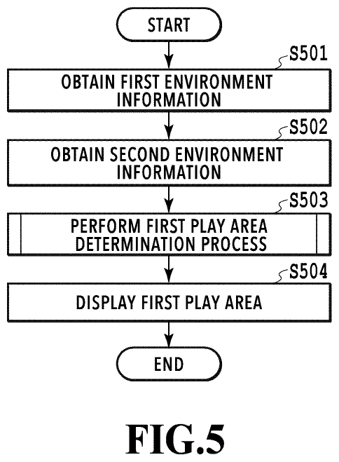

FIG. 5 is a flowchart illustrating an entire flow of a process in the first embodiment. An entire flow of a process in the first embodiment executed by the image processing apparatus 102 will now be described using FIG. 5. The process illustrated in the flowchart is written as a program that is readable to the CPU 301, and is stored in the ROM 304 or the HDD 305 of the image processing apparatus 102. The program is called and loaded to the RAM 303 by the CPU 301 and is executed by the CPU 301. The CPU 301 starts the process in a case where the HMD 101 is powered on and communication is established between the HMD 101 and the image processing apparatus 102. Each symbol “S” in the following description means a step.
In S501, the CPU 301 (first environment information obtaining unit 401) obtains information on the environment around the first user (first environment information). In the present embodiment, the CPU 301 obtains real images, a depth image, and position-orientation information captured and detected by the HMD 101 worn by the first user as the first environment information.
In S502, the CPU 301 (second environment information obtaining unit 402) obtains information on the environment around the second user (second environment information). In the present embodiment, the CPU 301 obtains real images, a depth image, and position-orientation information captured and detected by the HMD 101 worn by the second user as the second environment information.
In S503, the CPU 301 (play area determination unit 403) determines the first play area, which is a play area for the first user, based on the information on the environment around the first user and the information on the environment around the second user. In the first embodiment, the CPU 301 (play area determination unit 403) determines the first play area based on the size of the room of the first user and the size of the room of the second user. Details of the process will be described later.
In S504, the CPU 301 (notification unit 404) notifies the first user of the first play area determined in S503. For example, the CPU 301 (notification unit 404) displays the first play area on the displays 203 and 203 of the HMD 101 used by the first user. In one example of the method of displaying the first play area to the first user, translucent virtual objects are displayed at the boundary surfaces between the inside and outside of the first play area.

### (Details of First Play Area Determination Process in First Embodiment)

In the first play area determination process in the first embodiment, the first play area is determined based on the sizes of the rooms of the users determined from the first environment information obtained in S501 and the second environment information obtained in S502.

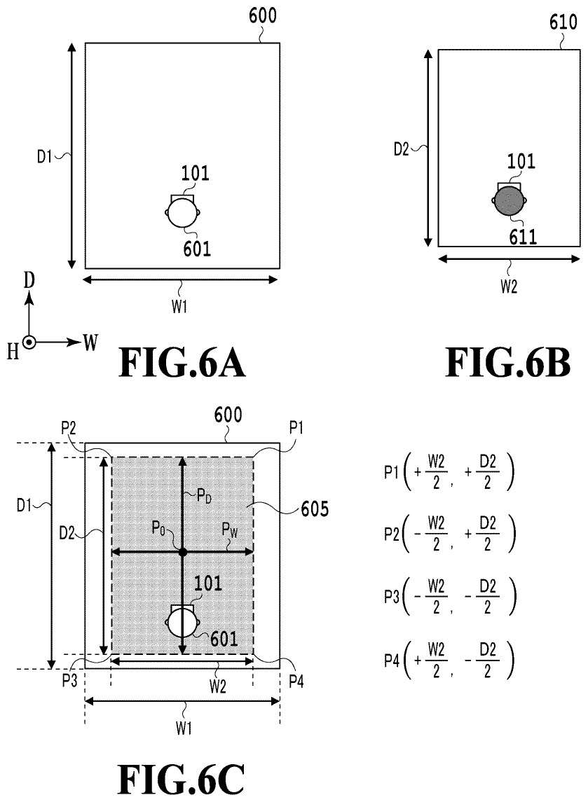

FIGS. 6A to 6C are diagrams generally illustrating the first play area determination process in the first embodiment. The first play area determination process in the first embodiment will now be generally described using these diagrams. FIGS. 6A to 6C illustrate plan views of rooms in which the direction perpendicular to the sheet surface is the direction of gravity (the height direction of the rooms). First and second users 601 and 611 are in different rectangular rooms 600 and 610 in real spaces, respectively (FIGS. 6A and 6B). In this process, the CPU 301 firstly detects the positions of the walls in each room. Then, the CPU 301 determines distances W1 and D1 between the facing walls in the room of the first user and distances W2 and D2 between the facing walls in the room of the second user. Since the room of each user is assumed to be rectangular, the distances between the facing walls are determined to be distances in two directions perpendicular to each other. The wall-to-wall distances in these two directions determine the size of the room. Lastly, the CPU 301 compares the wall-to-wall distance of each room in each direction to that of the other room, and determines a range having the smaller value (distance) in each direction as the size of the first play area. In FIGS. 6A and 6B, in which W1>W2 and D1>D2, W2 and D2 are the smaller values in the two directions, so that the region inside the dashed line in FIG. 6C is determined as the range of a play area 605. Specifically, a range P_{W} of the play area 605 in the lateral direction is W2, and a range Pp of the play area 605 in the depth direction is D2. Note that this range is the maximum range of the first play area. Further, the CPU 301 may determine any range smaller than this maximum range as the range of the first play area by, for example, including a margin.

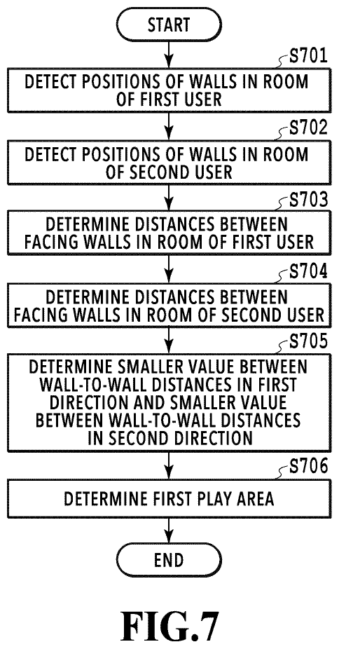

FIG. 7 is a flowchart illustrating a flow of the first play area determination process in the first embodiment. The flow of the first play area determination process in S503 will now be described using FIG. 7.
In S701, the CPU 301 (wall position detection unit 411) detects the positions of the walls in the room of the first user based on the real images, the depth image, and the position-orientation information of the room of the first user obtained in S501. In the present embodiment, the positions of the walls are detected as follows. First, using Visual SLAM, the CPU 301 determines the three-dimensional shapes of the surroundings around the first user from the real images, the depth image, and the position-orientation information obtained from the HMD 101 of the first user. This is obtained, for example, in the form of point cloud data indicating the three-dimensional positions of detected feature points.

Also, the CPU 301 detects the wall regions from the real images by using the object detection algorithm YOLO, and associates them with the three-dimensional shapes obtained by Visual SLAM. As a result, the CPU 301 obtains data in which the positions of feature points included in the point cloud data and object identification labels (e.g., wall) are associated with each other. In this way, the three-dimensional positions of the walls present around the first user can be determined. Visual SLAM and YOLO are publicly known technologies, and description thereof is therefore omitted.
In S702, the CPU 301 (wall position detection unit 411) detects the positions of the walls in the room of the second user based on the real images, the depth image, and the position-orientation information of the room of the second user obtained in S502. The method of detecting the positions of the walls is similar to S701.
In S703, the CPU 301 (wall-to-wall distance determination unit 412) identifies the room region of the first user based on the positions of the walls in the room of the first user detected in S701. Then, the CPU 301 determines the wall-to-wall distances in two perpendicular directions in a plane perpendicular to the height direction. The wall-to-wall distances are determined as follows. First, the CPU 301 separates the walls detected in S701 by planes. This can be performed by using a plane estimation algorithm, such as Random Sample Consensus “RANSAC,” for example. The positional relationship between the walls is detected by this process.

Then, the CPU 301 determines the position of the center of gravity of each separated wall. Thereafter, assuming that the position of each wall is the position of the center of gravity of the wall, the CPU 301 determines the distance between the wall at the farthest position from the position of the first user and the wall facing that wall. For example, the CPU 301 determines the distance between the walls in front of and behind the user. The CPU 301 determines the direction between these walls as the first direction (depth direction). The wall-to-wall distance in the first direction is determined as the Euclidean distance between the positions of the walls in the depth direction and the lateral direction, disregarding the position of the center of gravity of each wall in the height direction. Further, the CPU 301 determines the distance between the facing walls in a direction that is rotated 90° from the first direction about the height direction, i.e., the second direction (lateral direction) perpendicular to the first direction and the height direction. For example, the CPU 301 determines the distance between the walls to the left and right of the user position as the wall-to-wall distance in the second direction. The wall-to-wall distance in the second direction is also determined as the Euclidean distance between the positions of the walls in the depth direction and the lateral direction, disregarding the position of the center of gravity of each wall in the height direction.

By the process of S703, as illustrated in FIG. 6, the wall-to-wall distances D1 and W1 in the first and second directions are determined. The wall-to-wall distance in the first direction described above is D1, and the wall-to-wall distance in the second direction described above is W1. Note that “lateral direction” and “depth direction” are expressions for description using drawings, and do not necessarily need to match the coordinate axes in the three-dimensional shape data determined (point cloud data) in S701.
In S704, based on the positions of the walls in the room of the second user detected in S702, the CPU 301 (wall-to-wall distance determination unit 412) determines the wall-to-wall distance in two perpendicular directions in a plane perpendicular to the height direction. The method of determining the wall-to-wall distance in the two perpendicular directions is similar to S703. By this process, W2 and D2 in FIG. 6B are determined. Here, W2 denotes the wall-to-wall distance in the second direction, and D2 denotes the wall-to-wall distance in the first direction.
In S705, the CPU 301 (determination unit 413) compares the wall-to-wall distances W1 and D1 of the room of the first user derived in S703 and the wall-to-wall distances W2 and D2 of the room of the second user derived in S704, and determines the ranges P_{W} and P_{D} of a play area in the two perpendicular directions. Specifically, for each of the first and second directions of the play area, the CPU 301 compares the values of the wall-to-wall distances in the direction, and determines the smaller value as the range of the play area. That is, the CPU 301 determines the smaller value between D1 and D2 as the range P_{D} of the play area in the first direction. Also, the CPU 301 determines the smaller value between W1 and W2 as the range P_{W} of the play area in the second direction.
In S706, the CPU 301 (determination unit 413) determines the first play area 605 based on the ranges P_{D} and P_{W} of the play area in the first and second directions determined in S705. This is determined as follows. First, the CPU 301 determines the coordinates of the center of gravity of the walls' centers of gravity determined in S703, i.e., the coordinates of the center of the room of the first user. Then, the CPU 301 determines the center of the room of the first user as a center position P₀ of the first play area 605. Further, the CPU 301 determines a range of ±D2/2 in the first direction from the center position P₀ and a range of +W2/2 in the second direction from the center position P₀ as the range of the first play area 605. As a result, a rectangular region whose size in each of the first and second directions is the smaller value between the wall-to-wall distances of the two rooms in the direction is determined as the first play area 605. Note that the range of the first play area 605 in the height direction may be the entire range. The “entire range” refers to the entire range in the height direction in the data indicating the three-dimensional shape of the room, and includes at least the range from the floor surface to the ceiling surface of the room 600 of the first user.

For example, in the example of FIG. 6, the smaller value between the wall-to-wall distances of the two rooms in the lateral direction is W2, and that in the depth direction is D2, so that the size of the first play area 605 is determined as W2×D2. The following range is determined as the first play area 605 on the assumption that the center position of the room 600 of the first user is the center position P₀ of the first play area 605.

$$- W 2 / 2 < W < + W 2 / 2$$

$$- D 2 / 2 < D < + D 2 / 2$$

The rectangular range defined by a point P1 (+W2/2, +D2/2), a point P2 (−W2/2, +D2/2), a point P3 (−W2/2,−D2/2), and a point P4 (+W2/2,−D2/2) illustrated in FIG. 6C is the ranges of the first play area 605 in the first and second directions.

The CPU 301 appends label information as an identifier of a play area to coordinates corresponding to the first play area 605 in the data representing the space of the room region of the room 600 of the first user.

By the above process, the first play area is determined based on not only the information on the environment around the host user, who is the first user, but also the information on the environment around the second user, who is the partner in the remote communication. In this way, the range within which the first user can move, i.e., the first play area 605, is determined so as to avoid the problem of the 3D model of the first user appearing to be partly sticking into a wall in a room 610 of the second user from the perspective of the second user. This prevents the 3D model of the host user from appearing to be partly sticking into a wall in the room of the other user even in a case where the sizes of the rooms of the host user and the other user are different.

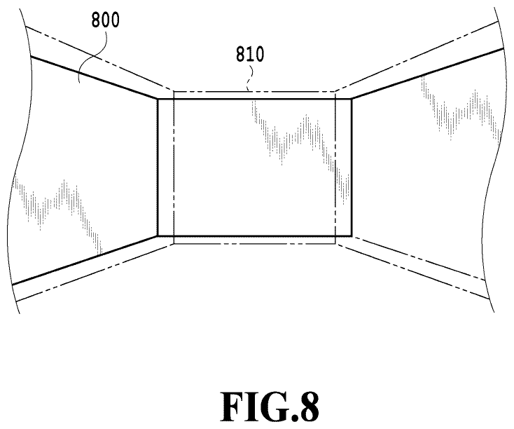

FIG. 8 is a display example of the first play area displayed on the HMD 101 used by the first user. The solid lines represent walls 800 present in the real space, and the dashed lines represent boundary surfaces 810 of the play area. The boundary surfaces 810 of the play area are displayed translucently on the near side of the walls 800 in the real space.

Note that the range in the room of the second user within which the second user can move, i.e., a second play area, can be determined by causing the image processing apparatus 102 connected to the HMD 101 used by the second user to execute a similar process. According to the above-described process, the range of the second play area will be equal to the first play area. In the example illustrated in FIGS. 6A to 6C, the size of the room of the second user is smaller than the room of the first user in both the depth direction and the lateral direction, and the second play area is therefore the whole room of the second user.

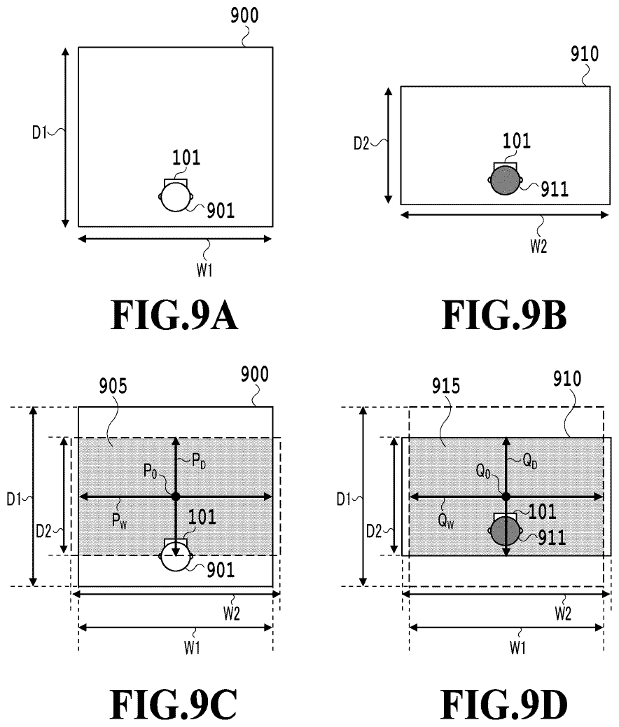

FIGS. 9A to 9D illustrate a room 900 of a first user 901 and a room 910 of a second user 911 in another example. As illustrated in FIG. 9A, the size of the room 900 of the first user is W1 in the lateral direction and D1 in the depth direction. As illustrated in FIG. 9B, the size of the room 910 of the second user is W2 in the lateral direction and D2 in the depth direction. Here, the room 910 of the second user is wider in the lateral direction (W1<W2), and the room 900 of the first user is wider in the depth direction (D1>D2). By performing the process of S703 described above, the range of a first play area 905 is determined as P_{W}=W1 in the lateral direction and P_{D}=D2 in the depth direction. The range of a second play area 915 is the same as the size of the first play area 905 and determined as Q_{W}=W1 in the lateral direction and Q_{D}=D2 in the depth direction.

The first play area 905 in the room 900 of the first user is the range described below in a case where its center P_{O} is set at the center of the room 900 of the first user, as illustrated in FIG. 9C.

$$- W 1 / 2 < W < + W 1 / 2$$

$$- D 2 / 2 < D < + D 2 / 2$$

Thus, the range in the room 900 of the first user within which the first user can move is equal to the entire range of the room 900 of the first user in the lateral direction and is narrower than the range of the room 900 of the first user in the depth direction.

The second play area 915 in the room 910 of the second user is the range described below in a case where its center Q_{O} is set at the center of the room 910 of the second user, as illustrated in FIG. 9D.

$$- W 1 / 2 < W < + W 1 / 2$$

$$- D 2 / 2 < D < + D 2 / 2$$

Thus, the range in the room 910 of the second user within which the second user can move is equal to the entire range of the room 910 of the second user in the depth direction and is narrower than the range of the room of the second user in the lateral direction.

### Modification 1 of First Embodiment

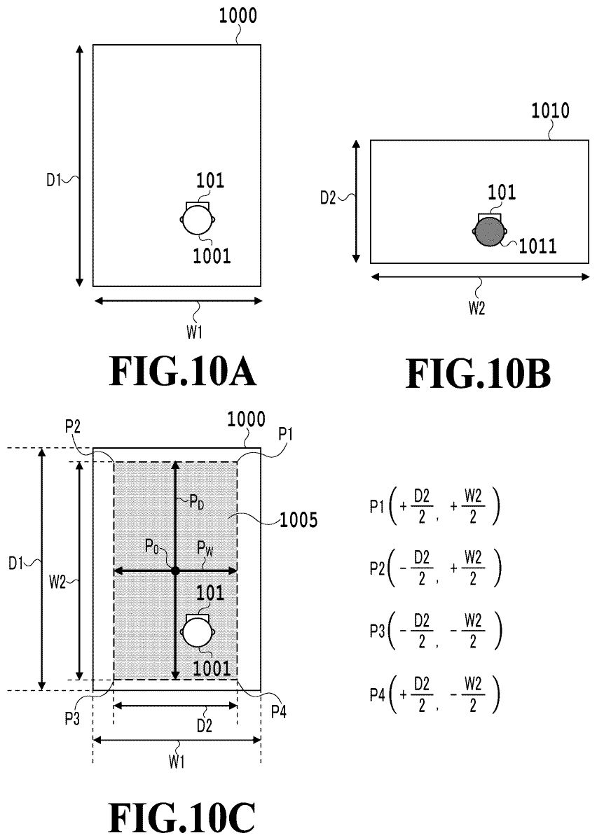

FIGS. 10A to 10C are diagrams describing Modification 1 of the first embodiment. As described above, the first embodiment involves comparing the wall-to-wall distances in the first direction to each other, comparing the wall-to-wall distances in the second direction to each other, and setting the smaller values as the ranges of the play area in the first and second directions. Alternatively, the comparison may be done with the directions switched. For example, in S705 in FIG. 7, the CPU 301 determines a sum diff0 of differences obtained by a comparison in the first direction and a comparison in the second direction, and a sum diff1 of differences obtained by comparisons in the first and second directions paired in a staggered pattern, as described in Equations (1) and (2) below. Then, the CPU 301 determines the combination with the smaller sum of differences. Thereafter, the CPU 301 determines the first play area based on the smaller values of the wall-to-wall distances in the combination with the smaller sum of differences, as described in Equations (3) and (4).

In Equations (1) to (4) below, W1 is the size of the room of the first user in the lateral direction, D1 is the size of the room in the depth direction, W2 is the size of the room of the second user in the lateral direction, and D2 is the size of the room in the depth direction. Also, P_{W} is the range of the play area in the lateral direction, and P_{D} is the range of the play area in the depth direction. Also, min(a, b) is a function that determines the smaller value between a and b.

$$diff 0 = \vert W 1 - W 2 \vert + \vert D 1 - D 2 \vert \qquad ( 1 )$$

$$diff 1 = \vert W 1 - D 2 \vert + \vert D 1 - W 2 \vert \qquad ( 2 )$$

In a case where diff0<diff1,

$${P}_{W} = min ( W 1 , W 2 ) , and {P}_{D} = min ( D 1 , D 2 ) \qquad ( 3 )$$

In a case where diff0≥diff1,

$${P}_{W} = min ( W 1 , D 2 ) , and {P}_{D} = min ( D 1 , W 2 ) \qquad ( 4 )$$

FIGS. 10A to 10C are diagrams describing the case where diff0≥diff1. As illustrated in FIG. 10A, the size of a room 1000 of the first user is W1 in the lateral direction and D1 in the depth direction. As illustrated in FIG. 10B, the size of a room 1010 of the second user is W2 in the lateral direction and D2 in the depth direction. Also, min(W1, D2)=D2, and min(D1, W2)=W2. In this case, sizes P_{W} and P_{D} of a first play area 1005 are D2 in the lateral direction and W2 in the depth direction, respectively, as illustrated in FIG. 10C. The rectangular range defined by a point P1 (+D2/2, +W2/2), a point P2 (−D2/2, +W2/2), a point P3 (−D2/2,−W2/2), and a point P4 (+D2/2,−W2/2) illustrated in FIG. 10C is the first play area 1005.

### Modification 2 of First Embodiment

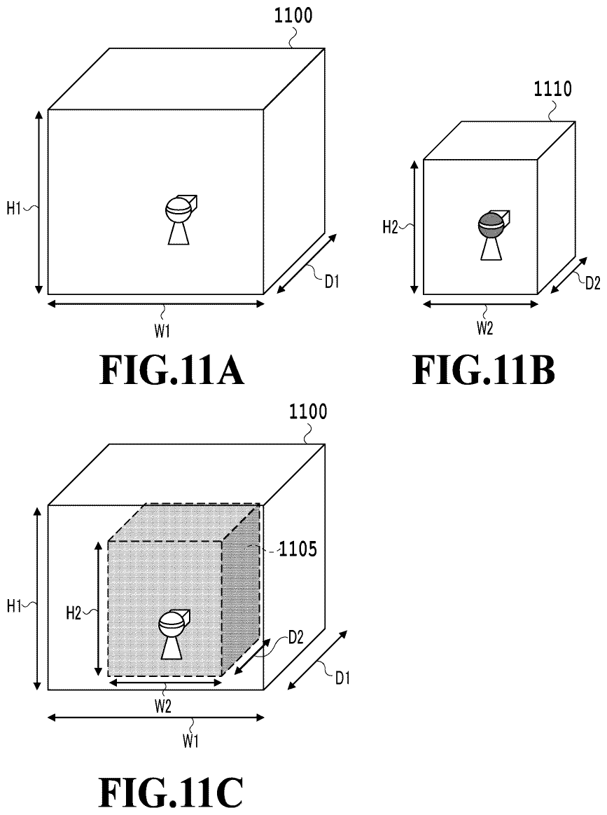

FIGS. 11A to 11C are diagrams describing Modification 2 of the first embodiment. As described above, the first embodiment has presented an example in which the range of the play area in the height direction is the entire range. Alternatively, the heights of the rooms of the first and second users may be compared to each other, and the smaller value may be set as the range of the play area in the height direction. In that case, in S701 and S702 in FIG. 7, the CPU 301, for example, detects a floor region and a ceiling region in addition to the wall regions from the three-dimensional shape data of the surroundings around each user. In S703 and S704, the CPU 301 determines the distance in the height direction between the centers of gravity of the floor region and the ceiling region. In S705, based on a height H1 of a room 1100 of the first user and a height H2 of a room 1110 of the second user, the CPU 301 determines the smaller value between the distances in the height direction. In S706, the CPU 301 determines a region from the floor surface of each room to a smaller value min(H1, H2) in the height direction determined in S705 as the range of a first play area 1105 in the height direction.

As illustrated in FIG. 11A, the size of the room 1100 of the first user is W1 in the lateral direction, D1 in the depth direction, and H1 in the height direction. Also, as illustrated in FIG. 11B, the size of the room 1110 of the second user is W2 in the lateral direction, D2 in the depth direction, and H2 in the height direction. The sizes of the first play area 1105 in the lateral direction and the depth direction are determined by the method in the first embodiment or its modification. The size of the first play area 1105 in the height direction is determined to be the smaller value between the distance H1 in the height direction of the room 1100 of the first user and the distance H2 in the height direction of the room 1110 of the second user. In the example of FIGS. 11A to 11C, in which H1>H2, the size of the first play area 1105 in the height direction is determined to be H2.

For instance, in the example of FIGS. 11A to 11C, the smaller value in the lateral direction is W2, the smaller value in the depth direction is D2, and the smaller value in the height direction is H2, so that the size of the first play area 1105 is W2×D2×H2. The center position on the floor surface of the room 1100 of the first user in the lateral direction and the depth direction is set as the origin, and the upward direction is set as the positive direction along the height direction. In that case, the following ranges are set as the first play area 1105.

$$- W 2 / 2 < W < + W 2 / 2$$

$$- D 2 / 2 < D < + D 2 / 2$$

$$0 < H < + H 2$$

### Modification 3 of First Embodiment

The first embodiment has described an example in which the HMD system 1 used by the first user determines the three-dimensional shape data of the room of the second user and the wall-to-wall distances of the room of the second user. However, the present disclosure is not limited to this. For example, in S502 in the flowchart of FIG. 5, the HMD system 1 used by the first user may obtain the wall-to-wall distances of the room of the second user determined by the HMD system 1 of the second user as the second environment information. In that case, the processes of S702 and S704 in the flowchart of FIG. 7 are not needed. Alternatively, the HMD system 1 used by the first user may obtain three-dimensional shape data (point cloud data) of the room of the second user determined by the HMD system 1 of the second user as the second environment information. In this way, in a case where the first user and the second user execute a play area determination process together, redundant processes will be omitted, allowing for efficient processing.

### Second Embodiment

The first embodiment has described a method of determining a play area for the first user based on the size of the room of each user. However, it is difficult to apply the process described in the first embodiment to a case where the shapes of the rooms are not rectangular. A second embodiment will describe a method of determining the first play area which is applicable to the case where the rooms of the users are not rectangular. Note that the second embodiment will mainly describe differences from the first embodiment and omit description of similar features.

### (Configuration of Image Processing Apparatus)

The hardware configurations of the HMD system 1, the HMD 101, and the image processing apparatus 102 according to the second embodiment are similar to those in the first embodiment, and description thereof is therefore omitted.

### (Functional Configuration of Image Processing Apparatus)

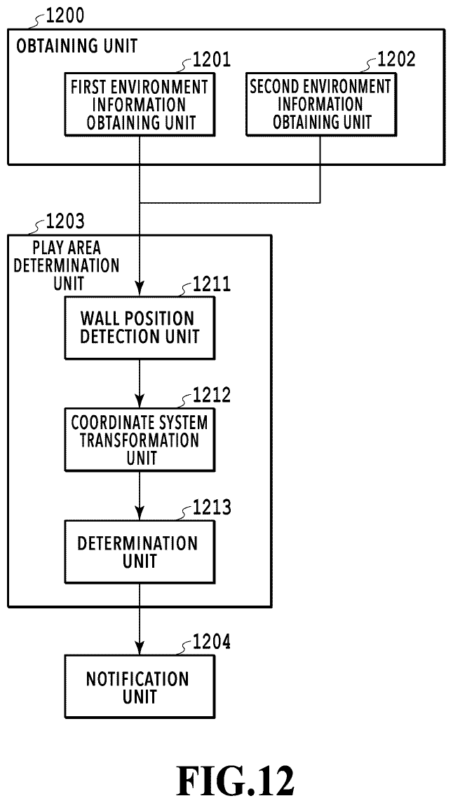

FIG. 12 is a diagram illustrating a functional configuration of the image processing apparatus 102 according to the second embodiment. The image processing apparatus 102 according to the second embodiment has an obtaining unit 1200, a play area determination unit 1203, and a notification unit 1204. The obtaining unit 1200 includes a first environment information obtaining unit 1201 and a second environment information obtaining unit 1202. The play area determination unit 1203 has a wall position detection unit 1211, a coordinate system transformation unit 1212, and a determination unit 1213.

The first environment information obtaining unit 1201, the second environment information obtaining unit 1202, the notification unit 1204, and the wall position detection unit 1211 are similar to the first environment information obtaining unit 401, the second environment information obtaining unit 402, the notification unit 404, and the wall position detection unit 411 in the first embodiment.

The coordinate system transformation unit 1212 performs coordinate transformation on the room of the first user such that the room of the first user and the room of the second user overlap each other. The coordinate system transformation unit 1212 determines a coordinate system that maximizes the overlapping region between the room of the first user and the room of the second user.

The determination unit 1213 determines the overlapping region between the room of the first user and the room of the second user determined by the coordinate system transformation unit 1212 as the first play area. It is preferable that the determination unit 1213 determine the first play area so as to maximize the size of the overlapping region. The determination unit 1213 compares the sizes of overlapping regions in multiple states obtained by translating and rotating the room region of the first user and the room region of the second user relative to each other with the floor surfaces of the room regions of the first and second users aligned with each other in height. The size of the overlapping region is, for example, the area of the floor surface or of a plane parallel to the floor surface in the overlapping region.

The range of the play area in the height direction is the entire range, as in the first embodiment. Alternatively, the range may be the smaller distance between the floor-to-ceiling distances of the room regions of the users.

### (Process Executed by Image Processing Apparatus)

The entire flow of the process in the second embodiment is similar to that in the first embodiment (FIG. 5). However, details of the first play area determination process in S503 are different from those in the first embodiment. The details of the first play area determination process in the second embodiment will now be described below.

### (Details of First Play Area Determination Process in Second Embodiment)

In the first play area determination process in the second embodiment, the CPU 301 (play area determination unit 1203) determines the first play area based on the overlapping region between the room of the first user and the room of the second user.

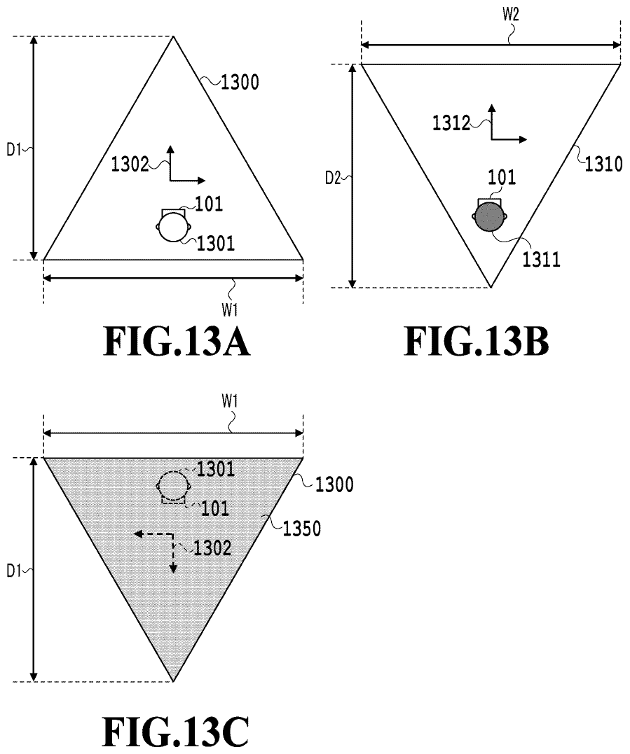

FIGS. 13A to 13C are diagrams generally illustrating the first play area determination process in the second embodiment. In FIGS. 13A to 13C, the direction perpendicular to the sheet surface represents the direction of gravity (the height direction of the rooms). Assume that a first user 1301 and a second user 1311 are present different triangular rooms 1300 and 1310 (FIGS. 13A and 13B). First, the CPU 301 detects the positions of the walls in each room. Next, the CPU 301 determines the coordinates of the center of the room based on the positions of the walls, and sets up coordinate axes with the determined coordinates as the origin and the direction of gravity as the height direction (reference signs 1302 and 1312 in FIGS. 13A and 13B). Then, the CPU 301 aligns the origin in the room 1300 of the first user and that in the room 1310 of the second user with each other, derives an overlapping region between planes that pass the origins and parallel to the floor surfaces, and determines the area of the overlapping region. The CPU 301 repeats this process while rotating the room 1300 of the first user about a height direction axis at intervals of Δθ to find a rotation angle at which the area of the overlapping region is largest. In the example of FIGS. 13A to 13C, the room 1300 of the first user and the room 1310 of the second user completely overlap each other in a state where the initial coordinate axes 1302 are rotated 180° as illustrated in FIG. 13C. Accordingly, the area of the overlapping region is largest. The CPU 301 determines the overlapping region with the largest area as a first play area 1350. That is, in the example of FIGS. 13A to 13C, the entire room 1300 of the first user is determined as the first play area 1350. Note that this range is the maximum range of the first play area 1350. Further, the CPU 301 may determine any range smaller than this maximum range as the range of the play area by, for example, including a margin.

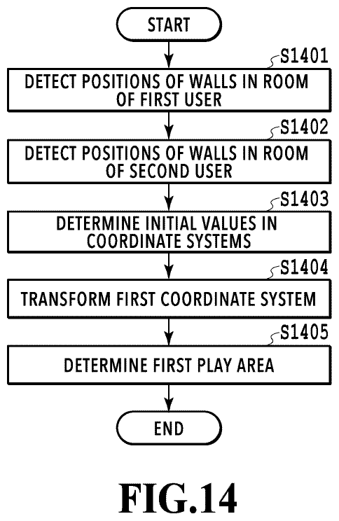

FIG. 14 is a flowchart illustrating a flow of the first play area determination process in the second embodiment. The flow of the first play area determination process in the second embodiment will now be described using FIG. 14.
In S1401, the CPU 301 (wall position detection unit 1211) detects the positions of the walls in the room of the first user based on the real images, the depth image, and the position-orientation information of the room of the first user obtained in S501. The method of detecting the positions of the walls is similar to S701, and may use Visual SLAM, the object detection algorithm YOLO, or the plane estimation algorithm RANSAC described above, or the like. By this process, the shape of the room is determined.
In S1402, the CPU 301 (wall position detection unit 1211) detects the positions of the walls in the room of the second user based on the real images, the depth image, and the position-orientation information of the room of the second user obtained in S502. The method of detecting the positions of the walls is similar to S701.
In S1403, the CPU 301 (coordinate system transformation unit 1212) determines an initial value in the coordinate system of each of the room of the first user and the room of the second user. The initial value is the position of the center of gravity from the detected positions of the walls, i.e., the center of the room, and is set as the coordinate origin. Also, the CPU 301 sets initial coordinate axes with the direction in which the user is facing at the start of S1403 as a positive direction in the depth direction (+D), with the direction rotated 90° clockwise therefrom as a positive direction in the lateral direction (+W), and with the opposite direction from the direction of gravity as a positive direction in the height direction (+H). The CPU 301 executes this process for each of the room of the first user and the room of the second user.
In S1404, the CPU 301 (coordinate system transformation unit 1212) transforms the coordinate system for the first user so as to maximize the overlapping region between the room of the first user and the room of the second user. In the present embodiment, the CPU 301 firstly superimposes the rooms of the first and second users one over the other with the origins and the directions of the coordinate axes set in S1403 aligned with each other. Next, the CPU 301 sets a plane with a constant height, i.e., a plane parallel to the floor surfaces, that passes the origins, and searches for a rotation angle Δθ, a lateral-direction movement amount ΔW, and a depth-direction movement amount ΔD that maximize the area of overlap between the rooms in that plane. The search ranges are the ranges of the room of the other user. Specifically, the search ranges are 0°≤Δθ≤360°, −W2/2≤ΔW≤+W2/2, and −D2/2≤ΔD≤+D2/2. Then, the CPU 301 performs coordinate transformation on the room of the first user into a coordinate system determined by the rotation angle Δθ, the lateral-direction movement amount ΔW, and the depth-direction movement amount ΔD that maximize the area of overlap between the rooms.
In S1405, the CPU 301 (determination unit 1213) determines the overlapping region after the coordinate transformation in S1404 as the first play area. As in the first embodiment, the range in the height direction may be the entire range, or the heights of the rooms of the first and second users may be compared to each other, and the smaller value may be set as the range of the play area in the height direction.

As described above, in the second embodiment, the first play area is determined based on the overlapping region between the room of the first user and the room of the second user, and the first play area can therefore be determined even in a case where the shapes of the rooms are not rectangular. This prevents the 3D model of one user from appearing to be partly sticking into a wall in the room of the other user regardless of the shapes of their rooms.

Note that a case where the rooms of the first and second users have the same shape and size has been described in the example of FIGS. 13A to 13C. However, even in a case where the rooms of the first and second users have different shapes and sizes, the process in the second embodiment can set a play area by the same processing method.

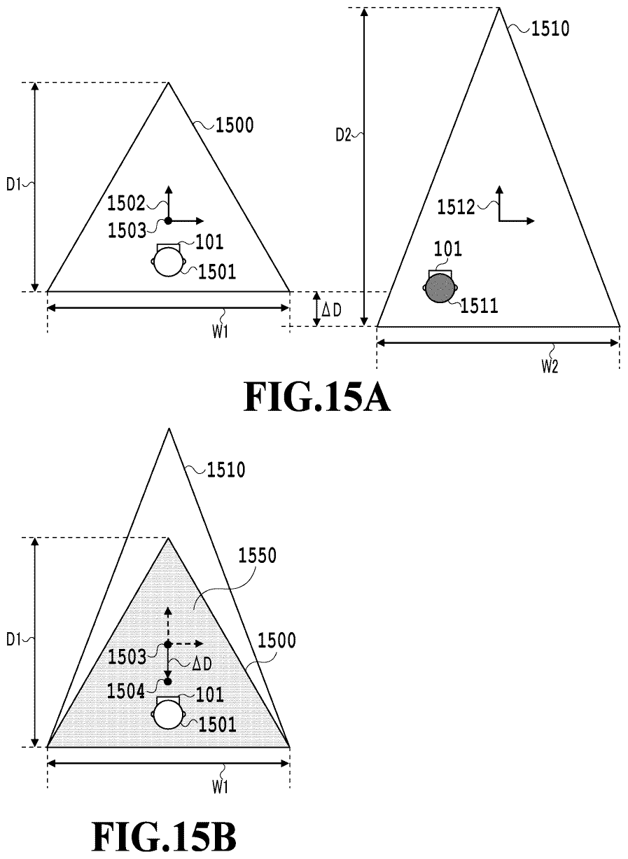

FIGS. 15A and 15B illustrate an example in which the rooms of the first and second users have different shapes, and their overlapping region is determined through translation. As illustrated in FIG. 15A, the room 1500 of the first user 1501 has a triangular shape with a size that fits within a rectangular frame measuring W1 in the lateral direction and D1 in the depth direction. The center position of the floor surface serves an origin 1503 for initial coordinate axes 1502. Also, as illustrated in FIG. 15A, the room 1510 of the second user 1511 has a triangular shape with a size that fits within a rectangular frame measuring W2 in the lateral direction and D2 in the depth direction. Here, the largest dimension of each room in the lateral direction is equal (W1=W2), and the room of the second user is wider in the depth direction (D1<D2). The overlapping region will become largest in a case where the room of the first user is translated by −ΔD as a result of the process of S1404 described above. In S1405, the CPU 301 determines the overlapping region after the translation (coordinate transformation) of the room of the first user by −ΔD as a first play area 1550, as illustrated in FIG. 15B. An origin 1504 of coordinate axes after the coordinate transformation is shifted by ΔD in the depth direction from the origin 1503 of the initial coordinate axes.

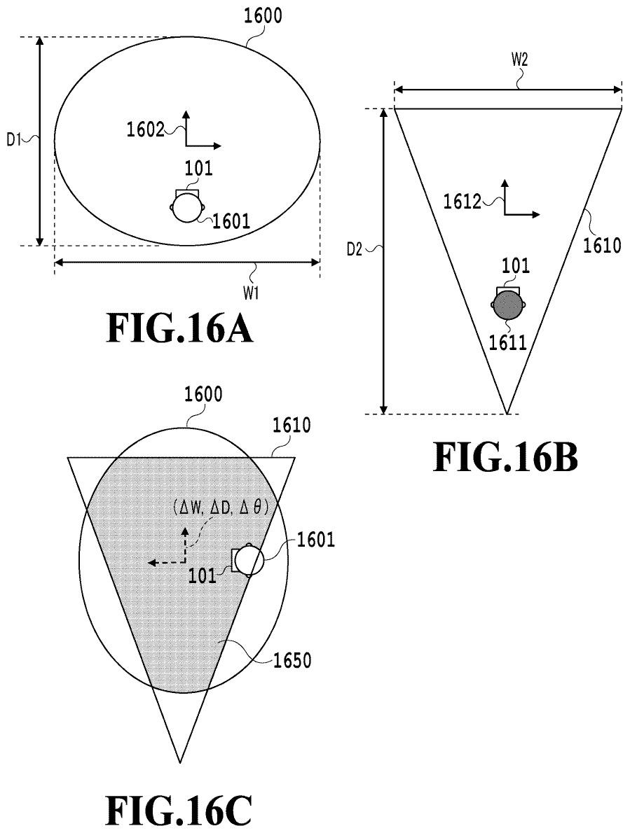

FIGS. 16A to 16C illustrate an example in which the rooms of the first and second users have different shapes, and their overlapping region is determined through translation and rotation. As illustrated in FIG. 16A, the room of the first user has an elliptical shape with a size that fits within a rectangular frame measuring W1 in the lateral direction and D1 in the depth direction. Also, as illustrated in FIG. 16B, the room of the second user has a triangular shape with a size that fits within a rectangular frame measuring W2 in the lateral direction and D2 in the depth direction. Here, the room of the first user is wider in the lateral direction (W1>W2), and the room of the second user is wider in the depth direction (D1<D2). The overlapping region will become largest in a case where the room of the first user with initial coordinate axes 1602 is rotated by Δθ and translated by ΔW in the lateral direction and ΔD in the depth direction as a result of the process of S1404 described above. In S1405, the CPU 301 determines the overlapping region as a first play area 1650. According to the second embodiment, the overlapping region between the rooms of the users can be determined to be a play area even in a case where the rooms have various shapes, such as one with a curved wall surface, for example. The shapes of the rooms are not limited to geometrical shapes, such as polygonal shapes, circular shapes, and elliptical shapes, and may be any shapes. The second embodiment is applicable even to a room with a shape having dents and protrusions in part of its walls.

### Third Embodiment

A third embodiment will describe a method of determining the (first) play area for the host user based on an obstacle in the room of the second user, who is the other user.

### (Configuration of Image Processing Apparatus)

The hardware configurations of the HMD system 1 and the image processing apparatus 102 according to the third embodiment are similar to those in the first embodiment.

### (Functional Configuration of Image Processing Apparatus)

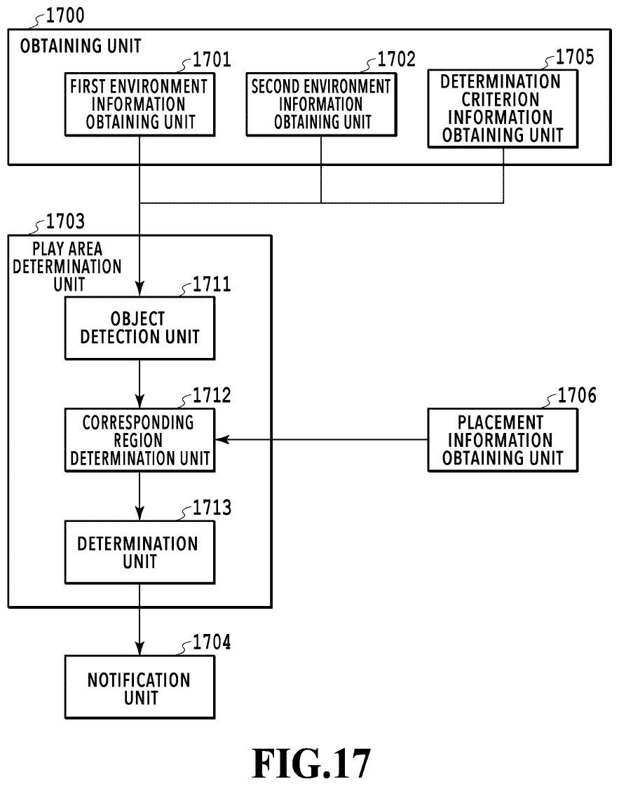

FIG. 17 is a diagram illustrating a functional configuration of the image processing apparatus 102 according to the third embodiment. The image processing apparatus 102 according to the third embodiment has an obtaining unit 1700, a play area determination unit 1703, a notification unit 1704, and a placement information obtaining unit 1706. The obtaining unit 1700 has a first environment information obtaining unit 1701, a second environment information obtaining unit 1702, and a determination criterion information obtaining unit 1705. The play area determination unit 1703 has an object detection unit 1711, a corresponding region determination unit 1712, and a determination unit 1713.

The first environment information obtaining unit 1701, the second environment information obtaining unit 1702, the notification unit 1704, and the determination unit 1713 are similar to the first environment information obtaining unit 401, the second environment information obtaining unit 402, the notification unit 404, and the determination unit 413 in the first embodiment. Also, in the third embodiment, the room regions of the first and second users are identified by a similar method to that in the first or second embodiment.

The determination criterion information obtaining unit 1705 obtains information to be used as a criterion for determining whether an object detected in the room of the second user is an obstacle. For example, in a case where information on the size of the first user is used as a criterion, the determination criterion information obtaining unit 1705 accepts input of the body height or volume of the first user, i.e., the host user.

The placement information obtaining unit 1706 obtains information on the position in the room of the second user at which the 3D model of the first user is to be placed.

The object detection unit 1711 detects objects present around the second user based on second environment information obtained by the second environment information obtaining unit 1702. Also, the object detection unit 1711 determines whether the detected objects will be obstacles based on the determination criterion information obtained by the determination criterion information obtaining unit 1705. In the present embodiment, information on the body height of the first user is obtained as the determination criterion information. The object detection unit 1711 determines whether the detected objects will be obstacles. For example, the object detection unit 1711 sets a value that is equal to ½ of the obtained body height of the first user as a threshold value, and determines a detected object as an obstacle in a case where the largest value of the detected object in the height direction exceeds the threshold value. The object detection unit 1711 appends an identification label as an indicator of an obstacle region to the position of the region with the obstacle in the three-dimensional shape data of the room of the second user.

The corresponding region determination unit 1712 determines a region in the room of the first user corresponding to the obstacle region in the room of the second user. Hereinafter, the region in the room of the first user corresponding to the obstacle region in the room of the second user will be referred to as “corresponding region.” The corresponding region for the obstacle region in the room of the second user is determined based on the position in the room of the second user at which the 3D model of the first user is placed and the actual position of the first user in the room of the first user. More specifically, the corresponding region determination unit 1712 determines a transformation matrix T that transforms the actual position of the first user (X1, Y1, Z1) into the placement position obtained by the placement information obtaining unit 1706 (X, Y, Z). Then, the corresponding region determination unit 1712 performs coordinate transformation on the obstacle region in the room of the second user with an inverse transformation matrix T′ of the transformation matrix T. As a result, the corresponding region for the obstacle region in the room of the second user is determined. Details will be described later.

The determination unit 1713 determines the first play area based on the corresponding region for the obstacle region determined by the corresponding region determination unit 1712. Specifically, the determination unit 1713 determines a region obtained by removing the corresponding region from the room region of the first user as the first play area. Note that the corresponding region for the obstacle region will not be changed once it is determined. Regarding the height direction, the determination unit 1713 may just set a region obtained by removing, from the room region of the first user, the entirety of the corresponding region for the obstacle region in the height direction as the play area for the first user.

### (Process Executed by Image Processing Apparatus)

The entire flow of the process in the third embodiment is similar to that in the first embodiment (FIG. 5). However, details of the first play area determination process in S503 are different from those in the first embodiment. The details of the first play area determination process in the third embodiment will now be described below.

### (Details of First Play Area Determination Process in Third Embodiment)

In the third embodiment, the CPU 301 (play area determination unit 1703) sets a post-removal region being the room of the first user from which the corresponding region for the obstacle region in the room of the second user determined from the second environment information obtained in S502 is removed as the first play area.

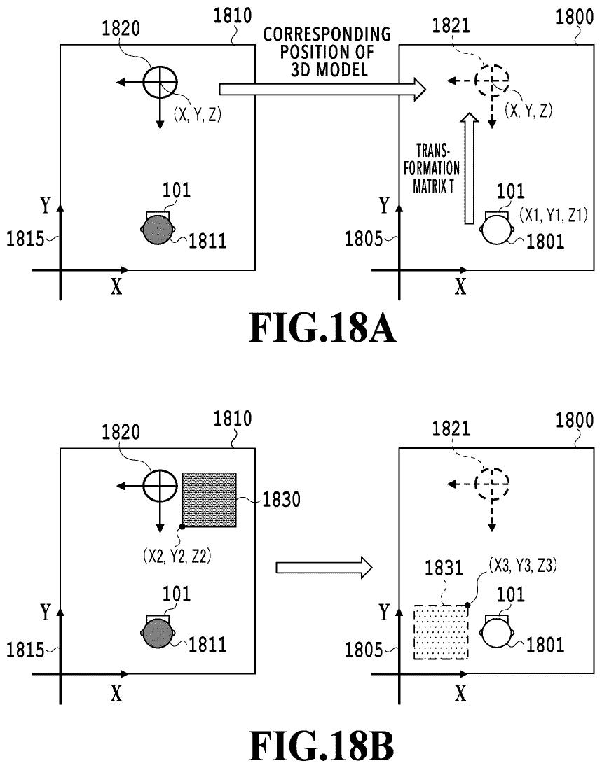

FIGS. 18A and 18B are diagrams generally illustrating the first play area determination process in the third embodiment. In FIGS. 18A and 18B, the direction perpendicular to the sheet surface represents the direction of gravity (the height direction of the rooms). First and second users 1801 and 1811 are in different rooms 1800 and 1810 in real spaces, respectively (FIG. 18A). As illustrated in FIG. 18A, a coordinate system 1805 is set in the room 1800 of the first user 1801, and a coordinate system 1815 is set in the room 1810 of the second user 1811.

First, the CPU 301 (object detection unit 1711) detects an object from the room 1810 of the second user and determines whether the detected object is an obstacle. Assume that an obstacle 1830 is determined to be present, as illustrated in FIG. 18B. Next, the CPU 301 (corresponding region determination unit 1712) determines the region in the room of the first user corresponding to the obstacle region 1830 in the room 1810 of the second user (corresponding region 1831). For example, assume that the HMD 101 of the second user displays a 3D model 1820 of the first user at a predetermined position in front of the current position of the second user 1811. In this case, the region in the coordinate system for the first user corresponding to the obstacle 1830 is at the position of a region 1831 in FIG. 18B. Lastly, the CPU 301 (determination unit 1713) determines a region 1802 obtained by removing the corresponding region from the room of the first user as the first play area.

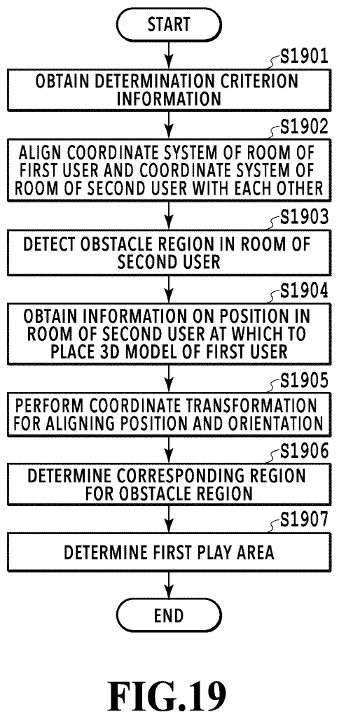

FIG. 19 is a flowchart illustrating a flow of the first play area determination process in the third embodiment. The flow of the first play area determination process in the third embodiment will now be described using FIG. 19.
In S1901, the CPU 301 (determination criterion information obtaining unit 1705) obtains determination criterion information for determining whether objects detected in the room of the second user are obstacles. In the present embodiment, information on the body height of the first user is obtained as the determination criterion information. The CPU 301 displays an input form for inputting the body height of the first user on the displays of the HMD 101 and accepts an input.
In S1902, the CPU 301 aligns the coordinate system of the room of the first user and the coordinate system of the room of the second user with each other. For example, the CPU 301 sets an origin at one of the four corners of each room. Axes extending along the room's wall from that origin in the lateral direction, the depth direction, and the height direction are set as the X axis, the Y axis, and the Z axis, respectively. Note that any method may be employed to set up the coordinate system. For example, the origin may be the center of the room or the position of a marker placed in the room in advance.
In S1903, the CPU 301 (object detection unit 1711) detects an obstacle present in the room of the second user based on the second environment information obtained in S502. In the present embodiment, the CPU 301 firstly obtains the three-dimensional shapes of the surroundings around the second user by Visual SLAM, and identifies and detects the walls and object regions other than the walls by YOLO. Then, for each of the detected object regions, the CPU 301 determines whether the object region is an obstacle based on the determination criterion information. In the present embodiment, the CPU 301 determines an object region as an obstacle region in a case where the length of the long side of the object region is more than or equal to the body height of the first user obtained in S1901. Note that the method of determining the size of an object as an obstacle is not limited to this. For example, whether an object region is an obstacle region may be determined based on other information, such as the body volume of the first user.
In S1904, the CPU 301 (placement information obtaining unit 1706) obtains information on a position at which the second user places the 3D model of the first user (hereinafter referred to as “placement position information”). For example, the CPU 301 transmits a request for the placement position information of the 3D model of the first user to the HMD system 1 (image processing apparatus 102) used by the second user. The HMD 101 used by the second user displays a message on its displays that prompts the second user to determine the position at which to place the 3D model. In response to the second user determining the position in the room of the second user at which to place the 3D model of the first user, the HMD system 1 used by the second user transmits information on that placement position (X, Y, Z) to the HMD system 1 of the first user. Since the coordinate system of the room of the second user and the coordinate system of the room of the first user have been aligned with each other in S1902, the corresponding position in the room of the first user at which to place the 3D model of the first user is obtained as (X, Y, Z).
In S1905, the CPU 301 determines a coordinate transformation for aligning the actual position of the first user in the room of the first user (X1, Y1, Z1) with the corresponding position of the 3D model of the first user (X, Y, Z). Here, the orientation is a reference orientation with no inclination. The position of the first user (X1, Y1, Z1) at a time to during the execution of the flowchart (e.g., the start) is determined by performing the coordinate transformation on the position-orientation information detected by the HMD 101 (x, y, z) with the coordinate system set for the room. The CPU 301 determines the transformation matrix T for aligning the actual position of the first user (X1, Y1, Z1) with the corresponding position of their 3D model (X, Y, Z).
In S1906, the CPU 301 (corresponding region determination unit 1712) determines the corresponding region in the room of the first user that corresponds to the obstacle region in the room of the second user. Specifically, the CPU 301 performs coordinate transformation on the obstacle region 1830 in the room of the second user obtained in S1903 with an inverse transformation matrix T′ of the transformation matrix T determined in S1905. As a result, the corresponding region 1831 for the obstacle region 1830 is determined. A reference position of the obstacle region 1830 in the room of the second user is (X2, Y2, Z2). A reference position (X3, Y3, Z3) of the corresponding region 1831 for the obstacle region 1830 in relation to the actual position of the first user is determined by performing coordinate transformation on the reference position (X2, Y2, Z2) of the obstacle region 1830 with the inverse transformation matrix T′. A region which has its base at that reference position (X3, Y3, Z3) and has the same size as the obstacle region 1830 is set as the corresponding region 1831.
In S1907, the CPU 301 (determination unit 1713) determines a region obtained by removing the corresponding region 1831 determined in S1906 from the room 1800 of the first user as the first play area. Note that the entire range in the height direction of the corresponding region 1831 covering its ranges in the X and Y directions may be removed.

By the above process, the play area for the host user (first user) can be determined based on an obstacle present in the room of the second user, who is the other user. In this way, the range within which the first user can move, i.e., the first play area, can be determined so as to avoid the problem of the 3D model of the first user appearing to be partly sticking into a wall in the room 610 of the second user from the perspective of the second user. This prevents the 3D model of the host user from appearing to be partly sticking into a wall in the room of the other user even in a case where an obstacle is present in the room of the other user.

### Modification of Third Embodiment

A description has been given of an example in which, in the process in the third embodiment described above, the image processing apparatus 102 removes a region in the room of the first user corresponding to an obstacle present in the room of the second user from the room of the first user. However, the region to be removed may be not only a region corresponding an obstacle but also a region that is not visible to the second user, i.e., a region corresponding to a blind spot. The play area determination unit 1703 in the HMD system 1 used by the first user identifies a blind spot that is not visible from the viewpoint of the second user due to an object present in the room region of the second user. The play area determination unit 1703 then determines the region in the room region of the first user corresponding to the blind spot, and determines a region obtained by removing that corresponding region from the room region of the first user as the play area for the first user.

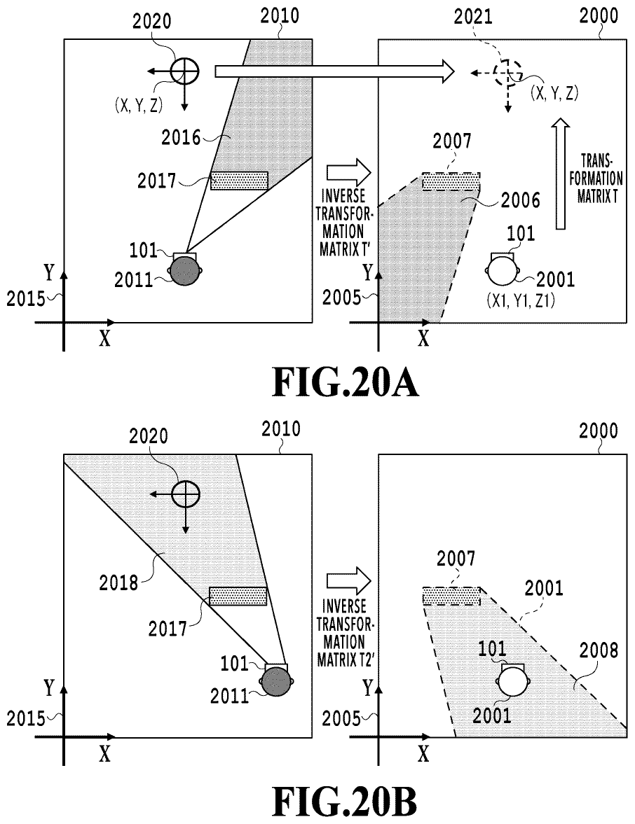

FIGS. 20A and 20B are diagrams describing a blind spot and its corresponding region. In a case where an obstacle 2017 is detected in a room 2010 of a second user 2011 as illustrated in FIG. 20A, the obstacle 2017 forms a region 2016 that is a blind spot from the viewpoint of the second user 2011. Also, in a case where the position and direction of the viewpoint of the second user change, a blind spot region 2018 as viewed by the second user 2011 will be different from the region 2016 illustrated in FIG. 20A even if the position of the obstacle 2017 remains the same, as illustrated in FIG. 20B.

After detecting the obstacle 2017 in a room 2010 of the second user 2011, the CPU 301 (object detection unit 1711) determines the blind spot 2016 formed by the obstacle 2017 that is based on the position-orientation information of the second user at a time t1. As in the process in the third embodiment described above, the CPU 301 (corresponding region determination unit 1712) determines the transformation matrix T for aligning the actual position of the first user (X1, Y1, Z1) with a corresponding position for the position at which the 3D model 2020 of the first user is to be placed (X, Y, Z). Then, the CPU 301 performs coordinate transformation on the blind spot 2016 with the inverse transformation matrix T′. As a result, as illustrated in FIG. 20A, a corresponding region 2006 in a room 2000 of the first user corresponding to the blind spot 2016 as viewed by the second user is determined. Note that the coordinate system of the room 2000 of the first user and the coordinate system of the room 2010 of the second user are aligned with each other.

As in the process in the third embodiment described above, the CPU 301 (determination unit 1713) determines the first play area based on the corresponding region 2006 for the blind spot determined by the corresponding region determination unit 1712. Specifically, the CPU 301 determines a region obtained by removing the corresponding region 2006 from the region of the room 2000 of the first user as the first play area at the time t1.

In a case where the second user's viewpoint position or viewing direction is changed, the CPU 301 determines the first play area at that time t2. Specifically, the CPU 301 determines the blind spot 2018 (FIG. 20B) formed by the obstacle 2017 that is based on the position-orientation information of the second user at the time t2. As in the process described above, the CPU 301 (corresponding region determination unit 1712) determines a transformation matrix T2 for aligning the actual position of the first user with a corresponding position for the position at which the 3D model 2020 of the first user is to be placed. Then, the CPU 301 performs coordinate transformation on the blind spot 2018 with an inverse transformation matrix T2′. As a result, as illustrated in FIG. 20B, a corresponding region 2008 in the room of the first user corresponding to the blind spot 2018 as viewed by the second user is determined. The CPU 301 (determination unit 1713) determines a region obtained by removing the corresponding region 2008 for the blind spot from the room region 2000 of the first user as the first play area at the time t2.

Regarding the height direction, the determination unit 1713 may just remove the entirety of the corresponding region for the blind spot in the height direction from the room region of the first user.

By the above process, the range within which the first user can move, i.e., the first play area, can be determined so as to avoid a problem in which the 3D model of the first user inside a blind spot as viewed by the second user is displayed. This prevents the 3D model of the host user (first user) from appearing to be partly sticking into a region that is not visible to the other user (second user).

As described above, in a situation where one user in a room is performing remote communication with another user in a different room through a network, an appropriate play area can be set up based on not only information on the environment around the one user but also information on the environment around the other user. This prevents the problem of a 3D model of one user being appearing to be partly sticking into a wall in the room of the other user, so that a sense of realism is maintained in the MR space.

Note that the present disclosure is not limited to the contents described in the above embodiments, and may be carried out by combining elements and concepts described in the embodiments. For example, from a play area determined based on the wall-to-wall distances of the rooms of the first and second users and the overlapping region between the rooms as described in the first or second embodiment, a region corresponding to an obstacle region in the room of the other user may be removed to determine a play area.

Also, the position in the room of each user at which to place the play area is not limited to the center of the room of the user, and may be any position inside the room of the user.

Also, each of the above embodiments has described an example of one-to-one communication in which a single second user is communicatively connected to a single first user, but the number of second users may be two or more. For example, assume a state where three users A, B, C are in different rooms and are communicatively connected to one another using respective HMD systems 1. In this case, the CPU 301 in the image processing apparatus 102 of the HMD system 1 used by the first user A obtains environment information of the user B and environment information of the user C as environment information of the second users. The environment information may be real images, a depth image, and position-orientation information as described above, or three-dimensional shape data and wall-to-wall distances of each room detected by the HMD system 1 used by the corresponding user. The CPU 301 determines the positions of the walls in the rooms of the users A, B, and C, and determines the wall-to-wall distances of the rooms of the users A, B, and C in the depth direction and the lateral direction. In that case, the CPU 301 determines the first play area as described in Equation (5) below.

$${p}_{w} = min ( W 1 , W 2 , W 3 ) , {P}_{D} = min ( D 1 , D 2 , D 3 ) \qquad ( 5 )$$

Here, the size of the room of the user A is W1 in the lateral direction and D1 in the depth direction, the size of the room of the user B is W2 in the lateral direction and D2 in the depth direction, and the size of the room of the user C is W3 in the lateral direction and D3 in the depth direction. In this case, the size P_{W} of the first play area in the lateral direction is determined to be the smallest value in the lateral direction among the rooms, and the size P_{D} of the first play area in the depth direction is determined to be the smallest value in the depth direction among the rooms.

Also, as described in Modification 1 of the first embodiment, the sizes P_{W} and P_{D} of the play area in the lateral direction and the depth direction may be determined by switching the lateral direction and the depth direction of each room. In this case, the sizes of the play area are preferably determined to be as large as possible. Similarly, the second and third embodiments are also applicable to cases where the number of second users is two or more.

Also, the above embodiments have described examples in which the processes illustrated in the respective flowcharts described above are performed while the HMD system 1 used by the first user and the HMD system 1 used by the second user are communicatively connected to each other and exchange information with each other. However, the present disclosure is not limited to this configuration. For example, a server capable of communicatively connecting to HMD systems 1 used by multiple users through a network may be provided, and this server may execute the processes described in the above embodiments. The number of servers is not limited to one, and multiple servers may cooperate with each other to perform the processes.

Also, the above embodiments have described examples in which the first and second users each use their HMD 101 to obtain information on the surrounding environment, but the present disclosure is not limited to this. For example, each user may use a camera, a smartphone, a tablet, or another terminal capable capturing images to obtain information on the surrounding environment.

According to the present disclosure, it is possible to determine a play area in remote communication between a first user and a second user.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-079579 filed May 15, 2024, which is hereby incorporated by reference wherein in its entirety.

What is claimed is:

1. An image processing apparatus for performing remote communication between a first user and a second user present in an environment different from an environment of the first user, comprising:
an obtaining unit configured to obtain first environment information being information for determining three-dimensional shapes of surroundings around the first user, and second environment information being information for determining three-dimensional shapes of surroundings around the second user; and
a determination unit configured to determine a play area for at least one of the first user and the second user for the remote communication based on the first environment information and the second environment information obtained by the obtaining unit.

2. The image processing apparatus according to claim 1, wherein the determination unit determines the play area based on a size of a room in which the first user is present that is determined based on the first environment information, and a size of a room in which the second user is present that is determined based on the second environment information.

3. The image processing apparatus according to claim 2, wherein the determination unit
detects positions of a plurality of walls present around the first user based on the first environment information, and determines the size of the room in which the first user is present based on a distance between the walls facing each other, and
detects positions of a plurality of walls present around the second user based on the second environment information, and determines the size of the room in which the second user is present based on a distance between the walls facing each other.

4. The image processing apparatus according to claim 3, wherein the determination unit determines the distance between the facing walls in each of at least two directions that are perpendicular to a height direction, and compares the distances between the facing walls in the at least two directions determined based on the first environment information and the distances between the facing walls in the at least two directions determined based on the second environment information.

5. The image processing apparatus according to claim 1, wherein the determination unit determines the play area based on an overlapping region between a room of the first user determined based on the first environment information and a room of the second user determined based on the second environment information.

6. The image processing apparatus according to claim 5, wherein the determination unit determines a region which maximizes a size of the overlapping region as the play area.

7. The image processing apparatus according to claim 5, wherein the determination unit compares sizes of the overlapping region in a plurality of states obtained by translating or rotating the room of the first user and the room of the second user relative to each other.

8. The image processing apparatus according to claim 6, wherein the determination unit compares sizes of the overlapping region in a plurality of states obtained by translating or rotating the room of the first user and the room of the second user relative to each other with a floor surface of the room of the first user and a floor surface of the room of the second user aligned with each other in height.

9. The image processing apparatus according to claim 2, wherein the determination unit sets a range covering entire ranges of the rooms in a height direction as a range of the play area in the height direction.

10. The image processing apparatus according to claim 2, wherein the determination unit sets a shorter distance between floor-to-ceiling distances of the rooms as a range of the play area in a height direction.

11. The image processing apparatus according to claim 1, wherein the determination unit
identifies a room region of the first user based on the first environment information,
identifies a room region of the second user and an obstacle region in the room region of the second user based on the second environment information,
determines a region in the room region of the first user corresponding to the obstacle region, and
determines a post-removal region obtained by removing the region corresponding to the obstacle region from the room region of the first user as the play area for the first user.

12. The image processing apparatus according to claim 11, wherein the determination unit determines the region in the room region of the first user corresponding to the obstacle region based on information on a position in a room of the second user at which to place a 3D model of the first user and information on an actual position of the first user in a room of the first user.

13. The image processing apparatus according to claim 11, wherein the determination unit identifies the obstacle region in the room region of the second user based on information on a size of the first user.

14. The image processing apparatus according to claim 1, wherein the determination unit
identifies a room region of the first user based on the first environment information,
identifies a room region of the second user and a blind spot based on the second environment information, the blind spot being not visible from a viewpoint of the second user due to an object present in the room region of the second user,
determines a region in the room region of the first user corresponding to the blind spot, and
determines a post-removal region obtained by removing the region corresponding to the blind spot from the room region of the first user as the play area for the first user.

15. The image processing apparatus according to claim 1, further comprising a display control unit configured to display the play area determined by the determination unit on displays on which the play area is visually recognizable to the users.

16. The image processing apparatus according to claim 1, further comprising a warning unit configured to give warning in a case where the user gets near a boundary between the play area and an outside.

17. The image processing apparatus according to claim 1, wherein the obtaining unit obtains real images and depth images captured from positions of viewpoints of the users and information on positions and orientations of the users as the first environment information and the second environment information.

18. The image processing apparatus according to claim 1, wherein the first environment information and the second environment information are obtained by head-mounted displays worn by the respective users.

19. An image processing method for performing remote communication between a first user and a second user present in an environment different from an environment of the first user, comprising:
obtaining first environment information being information for determining three-dimensional shapes of surroundings around the first user, and second environment information being information for determining three-dimensional shapes of surroundings around the second user; and
determining a play area for at least one of the first user and the second user for the remote communication based on the obtained first environment information and second environment information.

20. A non-transitory computer readable storage medium storing a program which causes a computer to execute an image processing method for performing remote communication between a first user and a second user present in an environment different from an environment of the first user, the image processing method comprising:
obtaining first environment information being information for determining three-dimensional shapes of surroundings around the first user, and second environment information being information for determining three-dimensional shapes of surroundings around the second user; and
determining a play area for at least one of the first user and the second user for the remote communication based on the obtained first environment information and second environment information.
